(19) United States
(12) Patent Application Publication
(10) Pub. No.: US 2006/0173916 A1
(43) Pub. Date: Aug. 3, 2006

(54) Method and system for automatically generating a personalized sequence of rich media

(76) Inventors: Timothy J. R. Verbeck Sibley, Washington, DC (US); Robert Rubinoff, Potomoc, MD (US); Anthony Rulz Davis, Takoma park, MD (US)

Correspondence Address: BROOKS KUSHMAN P.C., 1000 TOWN CENTER, TWENTY-SECOND FLOOR, SOUTHFIELD, MI, 48075, US

(21) Appl. No.: 11/315,438

(22) Filed: Dec. 21, 2005

Related U.S. Application Data
(60) Provisional application No. 60/637,764, filed on Dec. 22, 2004.

(51) Int. Cl. G06F 7/00

(52) U.S. Cl. 707/104.1

(57) ABSTRACT

A method of automatically creating a personalized media sequence of rich media from a group of media elements is performed. A media list that describes media elements that are appropriate to the personalized media sequence is received. The media elements described in the media list are combined into a coherent, personalized media sequence of rich media. The result is the creation of a personalized broadcast.

### CROSS-REFERENCE TO RELATED APPLICATIONS

This application claims the benefit of U.S. Provisional Application No. 60/637,764, filed Dec. 22, 2004.

### BACKGROUND OF THE INVENTION

1. Field of the Invention

The invention relates to a method and system for automatically creating personalized media sequences from a selected group of rich media files and segments of those files.

2. Background Art

The rapid growth of the Internet now includes rapid growth in the availability of digital, recorded, timed media such as: broadcast television, broadcast and streaming radio, podcasts, movies, and video-on-demand. As well, the very wide availability of digital audio and video technologies has led to the widespread existence of extensive digital rich media archives, available either via the Web or privately via intranets, created by educational institutions, government, private organizations, and private individuals. All of these technological drivers lead to an unprecedented wealth of rich media, from every source and in every genre, being available to orders of magnitude more users than ever before.

Searching and indexing technologies are also beginning to catch up to this flood of information. Techniques based on speech recognition, language processing, video image processing, and other indexing techniques, combined with the use of metadata (file name, source, date, genre, topic, actor or presenter names, and many other possible metadata types), are now powering technologies that attempt to arrive at a set of relevant rich media files and segments of files, based upon a user's needs and requests.

But note that even given such a list of appropriate media files and segments, the task of providing media resources to a user is still not complete.

Due to the time-dependent nature of rich media, the user cannot quickly scan a list of media segments and determine which are most promising, the way users commonly do with lists of search results for text searches. As well, the user cannot start viewing the selected portion of a media file, then quickly scan earlier in the file to find any missing contextual information. Again, the analogous operation in text is easy and commonly performed by many users; but in rich media, jumping back and forth in a media file, and listening to brief extracts in an effort to find information, is slow, difficult, and frustrating for most users.

Also, many rich media requests will be for purposes of entertainment, not education, and those users will often want a media experience more similar to watching a broadcast than to information-gathering activities such as searching, scanning, evaluating and selecting. Thus, the user will want a system capable of automatically combining the appropriate files and file segments into a coherent program.

So, to usefully or enjoyably benefit from a list of relevant media segments, many users will want to do some or all of the following:

View the segments as a unified sequence—a “personalized broadcast”—without the need for further clicking, choosing, or other user input.
View the segments with the most relevant, most recent, or other best segments (by any relevant criteria) placed earlier in the sequence.
View the segments in a sequence that is grouped logically according to content, source, or other relevant features.
Benefit from additional material in the sequence that fills in any background or contextual material missing from a media segment (content which is missing, most likely, because that segment is excerpted from its context).
Benefit from additional material in the sequence that bridges the transitions between adjacent media segments.

However, the processing necessary to make the selected media files and file segments available to the user in these ways is not possible with current technology: Presently, no automatic means exists for determining the topics of media segments and arranging them accordingly. A human editor would be needed to take the segments available from a query on natural disasters, for instance, and order them into a portion on hurricanes, and then a portion on earthquakes. Also, no current technologies can replace a human editor for catching references to missing contextual information from a media segment—“Later that day” or “Clinton then mentioned.” And no current technologies can automatically generate the information needed for a user to view the media segments—“Refers to Dec. 5, 2004” or “Senator Hilary Clinton.”

Prohibitive costs make it impossible for any system requiring human editing to provide access to a large pool of media, such as the rich media available on the Web. On-demand low-latency service is not only expensive, but impossible, via any human-mediated technology.

Further background information may be found in U.S. Patent Application Publication No. US 2005/0216443 A1, which is hereby incorporated by reference.

For the foregoing reasons, there is a need for a method and system for automatically generating a personalized sequence of rich media that overcomes these limitations of human processing and other deficiencies in the state of the art. There is a need for a method and system that removes one of the bottlenecks between the present huge (and ever-growing) pool of digitized rich media, and efficient, commodious, use of those resources by the millions of users to whom they are available.

### SUMMARY OF THE INVENTION

It is an object of the invention to provide a method and system for automatically creating personalized media sequences of rich media from a group of media elements such as media files and/or segments of those files. The rich media may include digitally stored audio, digitally stored video, timed HTML, animations such as vector-based graphics, slide shows, other timed media, and combinations thereof.

It is another object of the invention to make available a useful, coherent, and intuitive media sequence to a computer user, television viewer, or other similarly situated end user.

The invention comprehends a number of concepts that may be implemented in various combinations depending on the application. The invention involves a method and system, which may be implemented in software, that make it possible to combine portions of rich media files into topically coherent segments. In one aspect of the invention, the method and system provide an automatic way to detect the topics of the portions of rich media files, and group them according to these topics or according to other appropriate criteria.

In another aspect of the invention, the method and system detect necessary background or contextual information that is missing from a segment of rich media. The method and system may also detect necessary bridging information between the arranged segments of rich media files. For both of these sorts of missing information, the method and system may make it possible to automatically incorporate the missing information from other portions of the media files, or to automatically generate the missing information, as text, as generated speech, or in some other form, and insert this information at the appropriate points in the combination of media segments.

In accordance with the invention, the final result is a coherent, personalized, media sequence.

Various approaches may be taken to implement methods and systems in accordance with the invention. One contemplated approach requires the following inputs:
1. A media description. This is a description of the user's requirements for appropriate rich media materials. It may be derived from explicit user requests, including search terms; information from a user profile; information about user behavior; information about statistical properties of user requests, attributes, and behavior, for groups of users; and any combination of these and other information sources.
2. A media list. This is a description of which media files and segments of media files, from the available rich media resources, are appropriate to the given media request. This description may also include numeric scores indicating how appropriate each media file or segment is to the media request or to various elements of the media request.
3. The media files. These are the original digital rich media files from which the files and segments of files referred to in the media list are drawn.

In this particular approach to implementing the invention, based on these inputs, the method and system combine the media described in the media list into a coherent, personalized, media sequence for the user—a “personalized broadcast.” This sequence will be optimized for coherence, relevance, and other measures adding to the ease and enjoyment of the user. The sequence will also incorporate additional information adding to the coherence, ease of understanding, and enjoyability of viewing of the media sequence. This additional information will be gained from portions of the source media files that are not utilized in the segments referred to in the media list, as well as from other information sources.

At the more detailed level, the invention comprehends arranging media files and segments into sequences, detecting gaps in the media sequence, and repairing the gaps to produce the resulting personalized sequence of rich media. It is to be appreciated that the invention involves a variety of concepts that may be implemented individually or in various combinations, and that various approaches may be taken to implement the invention, depending on the application. The preferred embodiment of the invention is implemented in software. The method and system in the preferred embodiment of the invention allow the software to initiate appropriate processing so as to create personalized media sequences from a selected group of rich media files and segments of those files.

Arranging in Sequence

In the preferred embodiment of the invention, the method and system allow the software to automatically detect the topics of the media files and portions of rich media files in the media list. The method and system can also use this information to arrange the media files and segments into topically coherent sequences. As well, the system can use this information to arrange segments and topical sequences into larger sequences, again creating logical arrangements of media topics. The method and system can also use other sources of information, such as media broadcast dates or media sources, to arrange elements from the media list.

The method and system can also automatically detect the topics of the media files and portions of rich media files in the media list, and use this information to describe these topical groupings to the user.

Detecting Gaps

In the preferred embodiment of the invention, the method and system allow the software to detect gaps in a media sequence: these gaps are portions of the media sequence which are missing information that is necessary to comprehension of the media sequence. Missing information may be broadly categorized as:
1 Missing contextual or background information - information which may be present in the source media files, or in their associated metadata, but which is not present in the selected segments of those media files.
2. Missing bridging information - information indicating the relation between two adjacent media files or segments, in the order in which they appear in the media sequence.

Within these categories, types of gaps may include:
Document Context: Cases where the personalized broadcast needs to indicate the context from which a segment has been extracted.
Topic Shift: Instances in which a media segment starts a new topic.
Topic Resumption: Instances in which a media segment continues the topic of the preceding segment, but after a digression to irrelevant material in the source file.
Dangling Name Reference: Instances in which a partial name (e.g. “Karzai”) occurs in a media segment and the full name (e.g. “Hamid Karzai” or “President Karzai”) occurs in the media file but not in the extracted segment.
Dangling Time Reference: Instances in which a media segment uses a relative time reference (e.g. “today” or “last year”) without including an absolute date or time.
Dangling Pronoun: Instances in which a media segment uses a pronoun (e.g. “she,” “it,” “them”) without including a direct reference to the entity in question (“Senator Clinton,” “the U.S. trade deficit,” “the New York Mets”).
Dangling Demonstrative Pronoun: Instances in which a media segment uses a demonstrative pronoun (e.g. “this,” “that,” “these”) without including a direct reference to the entity in question (“the U.S.S. Intrepid,” “the flood's effects”).
Dangling Definite Reference: Instances in which a media segment employs a definite reference (“the decision”) to an entity fully identified outside the relevance interval (“Korea's decision to end food imports”).
Speaker Identification: Instances in which a speaker's identity is important to understanding a media segment, but the segment does not include the speaker's identity.
Missing Local Context: Instances in which a media segment's context or intent is unclear because of missing structural context (as when a segment begins with an indication such as “By contrast” or “In addition”).
Specified Relation: instances in which two media segments stand in a specific rhetorical relation which is helpful to understanding the segments (as: rebuttal, example, counterexample, etc.).

Other types of gaps may also be detected and repaired beyond those listed here.

Repairing Gaps

In the preferred embodiment of the invention, the method and system automatically fill in missing information by one of three methods:
Segment extension: extending the media segment backward in the source media file, to include the necessary information.
Content insertion: inserting an excerpt from elsewhere in the source media file, to include the necessary information.
Content generation: automatically generating a phrase or sentence conveying the missing information. This content may be output as text, automatically generated speech, or in some other form as appropriate.

### BRIEF DESCRIPTION OF THE DRAWINGS

FIG. 1 illustrates the inputs, outputs, and processing stages in the preferred embodiment of the invention; and

FIG. 2 illustrates gap identification and repair in the preferred embodiment of the invention.

### DETAILED DESCRIPTION OF THE PREFERRED EMBODIMENT

It is to be appreciated that the invention involves a variety of concepts that may be implemented in various combinations, and that various approaches may be taken to implement the invention, depending on the application. The following description of the invention pertains to the preferred embodiment of the invention, and all references to the invention appearing in the below description refer to the preferred embodiment of the invention. Accordingly, the various concepts and features of the invention may be implemented in alternative ways than those specifically described, and in alternative combinations or individually, depending on the application.

The preferred embodiment of the invention is implemented in software. The method and system in the preferred embodiment of the invention allow the software to initiate appropriate processing so as to create personalized media sequences from a selected group of rich media files and segments of those files.

The preferred embodiment of the invention may incorporate various features described in U.S. Patent Application Publication No. US 2005/0216443 A1, which has been incorporated by reference.

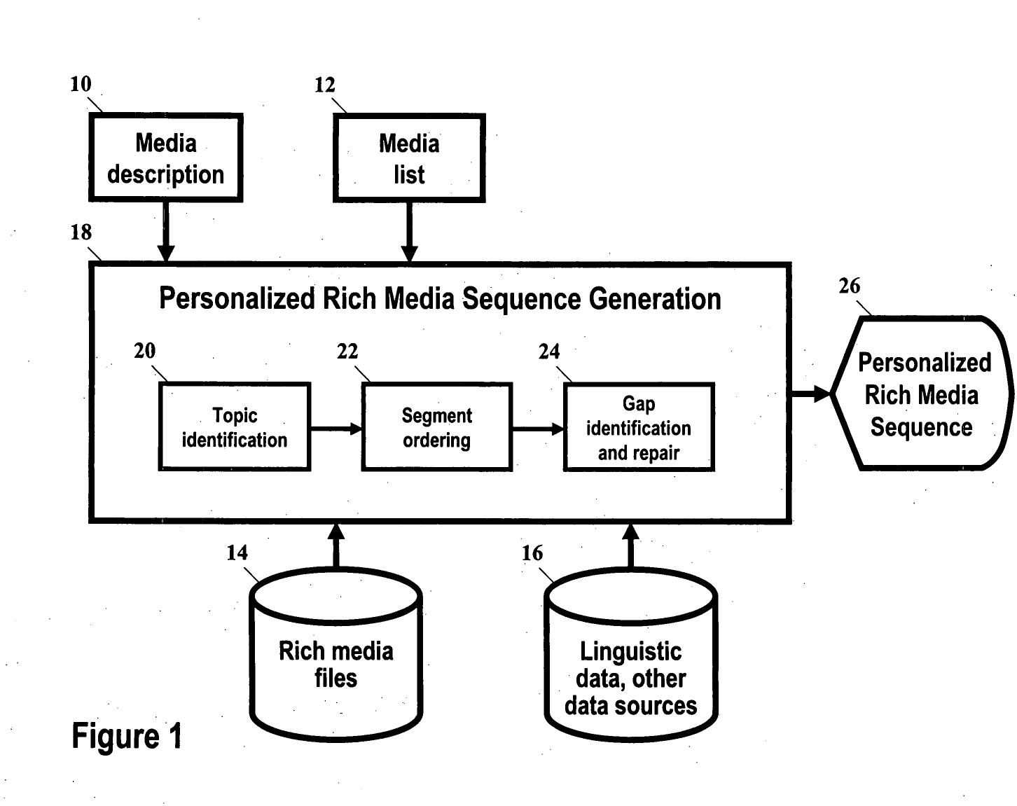

Overview of the Inputs, Outputs, and Processing Stages of the Invention (FIG. 1)

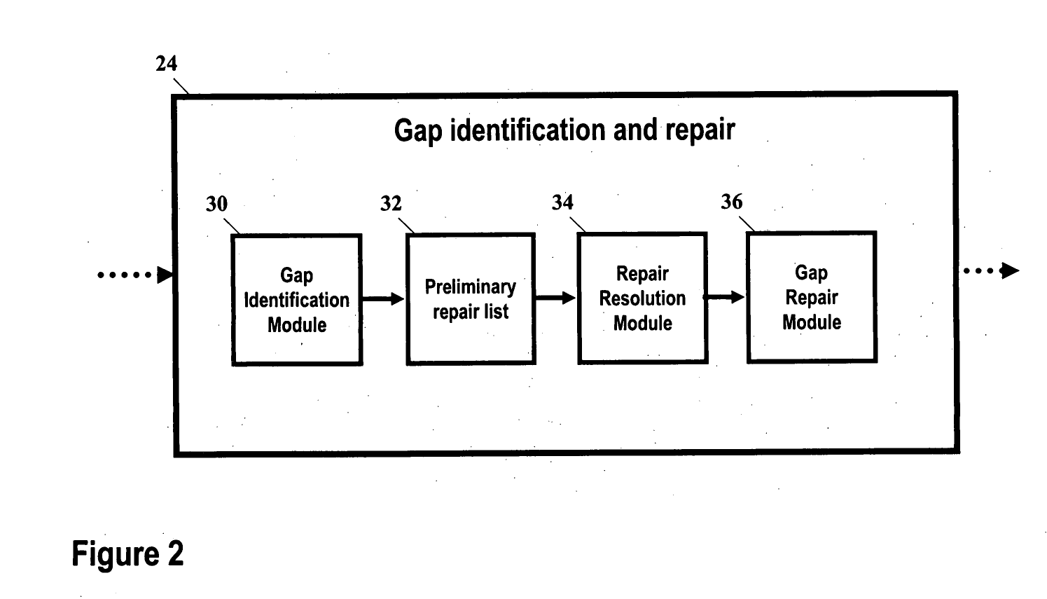

Media Description (10): This is a description of the user's requirements for appropriate rich media materials.
Media List (12): This is a description of which media files and segments of media files (collectively: media elements) from the available rich media resources, are appropriate to the given media description.
Rich Media Files (14): these are the original media files referred to in the media list. The rich media include digitally stored audio, digitally stored video, timed HTML, animations such as vector-based graphics, slide shows, other timed media, and combinations thereof.
Linguistic Data, Other Data Sources (16): This element refers to databases and other external data sources that may be used by the invention to perform its various functions. These data sources are described below in the detailed description of the invention.
Personalized Rich Media Sequence Generation (18): This is the central element of the preferred embodiment of the invention. Its functions can be described in terms of the next three components of FIG. 1.
Topic Identification Module (20): Described below.
Segment Ordering (22): Described below.
Gap Identification and Repair (24): Described below.
Personalized Rich Media Sequence (26): The final output.
   Sequence of Operations within the Gap Identification and Repair Module (FIG. 2)

The Gap Identification and Repair Module 24, in the preferred embodiment of the invention, generally involves four operations. In more detail, Gap Identification Module 30 detects gaps in a media sequence. These gaps are portions of the media sequence which are lacking information in a way that detracts from comprehension or pleasurable experience of the media sequence. Gap Identification Module 30 builds a preliminary repair list 32. Repair Resolution Module 34 takes the preliminary repair list 32 and harmonizes potential repairs to create the final repair list for Gap Repair Module 36. Gap Repair Module 36 modifies the personalized media sequence to perform the needed repairs by automatically filling in missing information using appropriate methods.

Technologies of the Invention

Information Extraction

Many techniques of this invention depend upon analysis of the content of the rich media files. A major portion of the data available from an audio-visual or audio-only media file will come via speech recognition (SR) applied to the file. The SR will record what word is spoken, when, for all of each media file. Because of the probabilistic nature of speech recognition, the speech recognition system also records alternatives for words or phrases, each alternative having a corresponding probability. As well, the speech recognition system records other aspects of the speech, including pauses and speaker changes.

Information is also extracted from visual information associated with media files via optical character recognition (OCR), HTML/SMIL parsing, and character position recognition. These capabilities record text that is visible as the viewer plays the media, and note characteristics of this text such as the size, position, style, and precise time interval of visibility.

In addition, any meta-data embedded in or stored with the media file is extracted. This can be as simple as the name of the file; more complete such as actor or presenter names, time and date of an event, or genre or topic of the file; or the complex description possible with a sophisticated metadata set, such as MPEG-7 meta-tags. Where a closed-caption or other transcript is available, that data will be incorporated as well.

Visual information, meta-data information, and transcripts will also be used to improve SR information, as OCR, HTML/SMIL parsing, and meta-data extraction are far more accurate than speech recognition.

The information extracted by these techniques is available to all other modules as described below.

The COW Model

To understand the semantic connection between portions of a media file, it is very useful to have a quantitative measurement of the relatedness of content words. A measurement is built up from a corpus using the well-known concept of mutual information, where the mutual information of word A and word B is defined by:
MI(A,B)=P(A&B)/[P(A)*P(B)],
where P(X) is the probability of the occurrence of word X.

To assist with the many calculations for which this is used, the system builds a large database of the mutual information between pairs of words, by calculating the co-occurrence of words within a window of a certain fixed size. The term COW refers to “co-occurring words.” This COW model is stored in a database for rapid access by various software modules.

Named Entity Identification and Co-Reference

Many techniques of this invention use data obtained by analyzing the information in the media files for mentions of named entities, and for co-references of names and pronouns.

Capabilities used for the invention include technologies to:
identify occurrences of named entities;
classify the entities by type, such as person, place, organization, event, and other categories;
determine whether multiple instances of named entities are referring to the same entity (e.g. “Hamid Karzai,” “Karzai,” and “President Karzai”);
determine which pronouns refer to a named entity, and which named entity is referred to.

Once all named entity references and co-references have been identified, the final output of these techniques is a co-reference table: this table includes the named entities identified, classified, and grouped according to the entity to which they refer; and the pronominal references identified, along with the antecedent to which they refer and the nature of the reference (e.g. direct vs. indirect). This co-reference table is stored in a database for rapid access by various software modules.

Centrality Calculation

Some techniques of this invention depend upon a measure of the centrality of content words occurring in the information from the media files. Centrality weights are assigned to each word based upon its part of speech, role within its phrase, and the role of its phrase within the sentence.

The final output of this technology is a table associating each word in the input media files with its centrality score. This centrality table is stored in a database for rapid access by various software modules.

Topic Identification Module (20)

The media list comprises a list of media elements appropriate to the media request. The system then implements techniques for representing each of these media elements in terms of the topics present in the element. All of these techniques operate to identify topic words, derived from the words in the media element, which typify the topics present. Different media elements can then be compared in terms of their different lists of topic words.

Topic words are found from within the set of potential topic words, or content words, in the document. In the current implementation, a content word is a noun phrase (such as “spaniel” or “the President”), or a compound headed by a noun phrase. A content word compound may be an adjective-noun compound (“potable water”), a noun-noun compound (“birthday cake”), or a multi-noun or multi-adjective extension of such a compound (“director of the department of the interior”). A list of topically general nouns, such as “everyone” and “thing” that may not be content words is also maintained.

The current implementation utilizes four algorithms for identifying topic words in a media element.

Early in Segment

The topic under discussion is often identified early in a segment. This approach therefore tags content words that occur early in the media element as potential topic words.

Low Corpus Frequency

Content words that occur in the media elements but occur infrequently in a large comparison corpus may be idiosyncratic words typical of the topic. This approach therefore tags such words as potential topic words.

The current implementation uses a corpus of all New York Times articles, 1996-2001, totaling approximately 321 million words. Other implementations of the invention may use other general-purpose corpora, or specialized corpora appropriate to the media elements, or combinations thereof.

High Segment Frequency

Content words that occur frequently in the media elements are also tagged as potential topic words.

Cluster Centers

For this approach, the invention uses information from the COW model described above. Content words which co-occur highly with other content words in the media element are judged likely to be central to the topics of the media element.

To find potential topic words via this approach, the current implementation first creates a table of co-occurrence values: For a media element containing n content words, this is an n×n matrix C where:
Cᵢⱼ=Cⱼᵢ=COW value of word i with word j.

These values are obtained from the database of large-corpus COW values.

In this matrix, positive values indicate words with positive mutual information—that is, words that tend to co-occur. The algorithm therefore sums the number of positive values each content word in the media element receives: For content word i,

$$s ( i ) = {\sum }_{j = 1}^{n} {0 otherwise}^{1 if {C}_{ij} > 0 ,}$$

Finally, higher scores s(i)—higher numbers of other content words in the media element that the word tends to co-occur with—indicate better potential topic words.

Combined Score

In the current implementation, the system uses a weighted sum of normalized scores from these four algorithms to determine the topic words of each media element. For each media element, it provides as output a list of topic words, together with confidence scores for each word.

Segment Ordering Module (22)

The Segment Ordering Module arranges the media elements referred to by the media list into an optimal ordering for greater coherence, ease of understanding, and enjoyability of viewing of the media sequence.

Topical Ordering

This module includes a procedure for ordering media elements based on their topical similarity. To do this, the procedure first calculates the overall similarity between every pair of media elements, as follows:

Let there be n media elements. For media elements Mₐ and M_{b}, with respective topic words tₐ₁, . . . , tₐₙ and t_{b1}, . . . , t_{bm}, let

$$similarity ( {M}_{a} , {M}_{b} ) = {\sum }_{{i}_{j} {=}_{=} {1 , n}_{1 , m}} COW ( {t}_{ai} , {t}_{bj} )$$

where COW(w, x) is the COW value of words w and x.

From these calculations on all pairs of media elements, the procedure constructs an n×n matrix S of similarity values, where
S_{gh}=S_{hg}=similarity(R_{g}, Rₕ)
Clustering

The resulting matrix of similarities, S, serves as input to the procedure for clustering media elements. This procedure clusters elements (rows, columns) in the matrix according to their pairwise similarities, to create clusters of high mutual similarity.

The present implementation uses Cluto v.2.1, a freely-distributed software package for clustering datasets. This implementation obtains a complete clustering from the Cluto package: a dendrogram, with leaves corresponding to individual media elements. Many other options for clustering software and procedures would also be appropriate for this task.

From this, media elements are gathered into clusters of similar content. Other ordering criteria, described next, serve to order elements within clusters and to order clusters within the whole personalized media sequence.

Other Ordering Criteria

Other criteria will be used by this module to order media elements within the personalized media sequence. Relevant criteria include:
pairwise similarity of media elements (to place most-similar elements consecutively, for instance);
source of media element;
date and time of creation or broadcast of media element;
date and time of occurrence (as for a news, sports-related, or historical item) of media element;
length of media element;
actors, presenters, or other persons present in the media element;
other elements of meta-data associated with the media element;
other specialized criteria appropriate to media elements from a particular field or genre;
other aspects of media elements not specifically named here.

These criteria will serve, for instance, to order media elements chronologically within clusters; or to order un-clustered media elements by source (e.g. broadcast network); and in many other ways to fully order media elements and clusters of media elements through combinations of the clustering procedure and these ordering criteria.

Topic Descriptors

For many applications, it is desirable to have a technique to indicate to the user the topics of the various clusters arrived at via clustering. For instance, the user interface might present information similar to:

| For your search on “Giants” | For your search on “cranes” |
|---|---|
| New York, football | birds: |
| <media element 1> | <media element 1> |
| <media element 2> | <media element 2> |
| San Francisco, baseball | <media element 3> |
| <media element 3> | construction: |
| <media element 4> | <media element 4> |
| <media element 5> | <media element 5> |
| etc. | etc. |

The details of the information presented and the user interface will of course vary extensively depending on the application.

The present implementation finds this information in the following manner:

Topic Descriptors, Algorithm 1

1. First, for each topical cluster derived, it obtains the set of all topic words for that cluster, by taking the union of the sets of topic words for all media elements in the cluster.
2. Next, the procedure finds the CIDE semantic domain codes of each topic word in this set. (CIDE, the Cambridge Dictionary of International English, places every noun in a tree of about 2,000 semantic domain codes. For instance, “armchair” has the code 805 (Chairs and Seats), a subcode of 194 (Furniture and Fittings), which is a subcode of 66 (Buildings), which is a subcode of 43 (Building and Civil Engineering), which is a subcode of 1 (everything).) From this, each topical cluster can be typified with a vector in the space of all CIDE semantic codes, as follows:
Let T be a topical cluster, with associated topic words t₁, . . . , tᵣ. The associated semantic vector V_{T}=(v₁, . . . , vₛ), for all s CIDE semantic codes, is defined by

$${v}_{j} = {\sum }_{i = 1 , r} 1 if {t}_{i} has semantic code j , 0 otherwise$$

for j in 1, . . . , s.
3. The procedure uses these semantic vectors to find terms that will meaningfully distinguish the clusters from each other for the user. Given two clusters, C and D, with associated semantic vectors V and W, the procedure finds the dimensions which indicate semantic codes which are significant for these topics, but also on which these topics differ appreciably. In particular, these are dimensions λ₁, . . . , λ_{q} for which both of the following are true:
   v_{λ}_{ᵢ}>M or w_{λ}_{ᵢ}>M or both;
   |v_{λ}_{ᵢ}−w_{λ}_{ᵢ}|>N
   for i in 1, . . . , q.
M is an appropriate norm, indicating that semantic vector components above M are relatively high, meaning that this is an important semantic dimension for this cluster.
N is an appropriate norm, indicating that a difference above N, for semantic vector components, shows semantic vectors that differ meaningfully in this semantic dimension.
4. Finally, the procedure identifies the topic words for each cluster which engender these significant dimensions of these significant vectors. For a cluster's set T of topic words, the procedure calculates the set S of potential topic descriptors, S⊂T, defined by:
   S={t εT|CIDE semantic code(t)=λᵢ, for some λᵢ, i in 1, . . . , q}
5. This algorithm of the invention then uses those topic words, or subsets of them, to describe the topical clusters.
Any suitable technique may be used to choose the final topical descriptors from the set of potential topical descriptors calculated above. In a simple approach, a sampling of topic words or all topic words are used as the descriptors.
   Topic Descriptors, Algorithm 2

In some cases, no dimensions λᵢ will satisfy the two conditions listed in step 3 above. For instance, a topical cluster of news stories related to hurricanes in Florida will score very similarly to a topical cluster of news stories related to hurricanes in Texas: both are related to weather, to natural disasters, to geographical areas in the United States, and so on. In such cases, this module employs the following modification of the above algorithm:
1. The algorithm calculates the topic word sets and associated semantic vectors for the clusters, as described in steps 1 and 2 above.
2. The procedure uses these semantic vectors to find terms that are central to the meaning of both clusters. Given two clusters, C and D, with associated semantic vectors V and W, the procedure finds dimensions λ₁, . . . , λ_{q} for which the following is true:
   v_{λ}_{ᵢ}>M and w_{λ}_{ᵢ}>M
   for i in 1, . . . , q.
M is an appropriate norm, indicating that semantic vector components above M are relatively high. Thus dimensions meeting the above requirement are important semantic dimensions for both clusters.
3. Finally, the algorithm identifies the topic words for each cluster which engender these significant dimensions of these semantic vectors. For a cluster's set T of topic words, the procedure calculates the set S of potential topic descriptors, S⊂T, defined by:
   S={t εT|CIDE semantic code(t)=λᵢ, for some λᵢ, i in 1, . . . , q}
In the above example, both “Florida” and “Texas” would be topic words generating high values in the same semantic dimension. Yet “Florida” and “Texas” themselves differ, and serve as meaningful labels to distinguish the two topical clusters.
4. This algorithm of the invention then uses those topic words, or subsets of them, to describe the topical clusters.
Any suitable technique may be used to choose the final topical descriptors from the set of potential topical descriptors calculated above. In a simple approach, a sampling of topic words or all topic words are used as the descriptors.
   Gap Identification Module (30)

The preliminary sequence of media elements, as produced by the Segment Ordering Module, is processed next by the Gap Identification Module.

This module detects gaps in a media sequence: these gaps are portions of the media sequence which are lacking information in a way that detracts from comprehension or pleasurable experience of the media sequence. Missing information may be broadly categorized as:
1. Missing contextual or background information—information which may be present in the source media files, or in their associated metadata, but which is not present in the selected segments of those media files.
2. Missing bridging information—information indicating the relation between two adjacent media files or segments, in the order in which they appear in the media sequence.
   Gap Types

Within both of these categories, this module is currently able to identify the following types of gaps:
Document Context: Cases where the media sequence needs to indicate the context from which a media element has been extracted.

The contextual identification needed will depend on the nature of the source and the excerpt. For instance, for a segment of broadcast news, the context information would consist of the date, time, and possible other information regarding the original broadcast news story. For an excerpt from a financial earnings call, the context information would consist of the company name, year and quarter of the call, and date of the call.
Topic Shift: Instances in which a media element starts a new topic, as determined by the invention's topic-based ordering algorithm.
Topic Resumption: Instances in which a media element continues the topic of the preceding media element, but after a digression to (omitted) irrelevant material in the source file.
Dangling Name Reference: Instances in which a partial name (e.g. “Karzai”) occurs in a media element and the full name (e.g. “Hamid Karzai” or “President Karzai”) occurs in the source media file but not in the extracted media element.
Dangling Time Reference: Instances in which a media element uses a relative time reference (e.g. “today” or “last year”) without including an absolute date or time.
Dangling Pronoun: Instances in which a relevance interval uses a pronoun (e.g. “she,” “it,” “them”) without including a direct reference to the entity in question (“Senator Clinton,” “the U.S. trade deficit,” “the New York Mets”).

In addition to the gap types defined above, further development of this module may yield techniques to identify and repair other types of gaps, including:
Dangling Demonstrative Pronoun: Instances in which a media element uses a demonstrative pronoun (e.g. “this,” “that,” “these”) without including a direct reference to the entity in question (“the U.S.S. Intrepid,” “IBM's decreased earnings,” “the sewer tunnels”).
Dangling Definite Reference: Instances in which a media element employs a definite reference (“the decision”) to an entity fully identified outside the media element (“Korea's decision to end food imports”).
Speaker Identification: Instances in which a speaker's identity is important to understanding a media element (as when a media source is presenting contrasting points of view), but the media element does not include the speaker's identity.
Missing Local Context: Instances in which a media element's context or intent is unclear because of missing structural context (as when a media element begins with an indication such as “By contrast” or “In addition”).
Specified Relation: instances in which two media elements stand in a specific rhetorical relation which is helpful to understanding the elements (as: rebuttal, example, counterexample, etc.).

Other types of gaps may also be detected and repaired beyond those listed here.

Gap Identification Procedures

Document Context

This gap occurs whenever the media file source of a media element differs from that of the previous media element. Basic file meta-data present in the media list lets the system know when a change of source file occurs in the personalized broadcast as constructed so far.

Topic Shift

The topic identification and segment ordering modules track information regarding the topics of the selected media elements. The gap identification module thus can identify all element boundaries that contain topic shifts, requiring no further analysis.

Topic Resumption

This gap occurs whenever two adjacent media elements come from the same source media file without a topic change between them. The same information used to identify document context and topic shift gaps will also allow the system to identify gaps of this type, without further analysis.

Dangling Name Reference

The co-reference table described previously identifies all occurrences of named entities within a media element, and in the element's entire source media file. Basic analysis of this information identifies occurrences of “partial names” in media elements—short versions of names, for which longer versions are present in the media file. Any partial name in the selected media element, whose longer co-reference occurs earlier in the source file but is not included in the media element, is a possible target for repair as a dangling name reference.

Not all such dangling name references will be marked for repair. The current implementation analyzes the need for repair through the combination of two scores:
1. Position in segment: references earlier in the media element are more likely to depend on preceding information that was not included in the media element. With increasing distance into the media element, dangling name references are decreasingly likely to need repair.
2. Centrality: Higher centrality score makes a reference more likely to need repair.

The present implementation calculates a normalized sum of these two scores, and marks for repair only those dangling name references scoring above a certain threshold. Other calculations for making this determination may be appropriate in various circumstances.

Dangling Time Reference

The present construction identifies dangling time references by matching the information from the selected media elements against a comprehensive list of templates for time-related expressions. The present construction uses the following list of such expressions:
day before yesterday
day after tomorrow
last week
last month
last year
last hour
this month
today
yesterday
tomorrow

Other constructions of the invention may employ a more extensive list of time expressions, along the lines of:
this<time reference>(“this year,” “this week,” etc.)
that<time reference>(“that day,” “that week,” etc.)
last<time reference>(“last year,” “last week,” etc.)
next<time reference>(“next year,” “next week,” etc.)
<time interval>later (“a week later”)
<time interval>ago (“several days ago”)
afterward(s)
earlier
later
previously
before
today
yesterday
tomorrow

A matching instance indicates a candidate for repair. In some implementations, a centrality score may be used, as with dangling name references, to determine which candidates warrant repair.

Dangling Pronoun

Identification of dangling pronoun gaps is similar to identification of dangling name reference gaps. Information from the co-reference table serves to identify all dangling pronouns in the media element—pronouns for which co-referential named entities are present in the media file but not included in the media element. Also as with dangling name gaps, the present implementation calculates a normalized sum of position and centrality scores to determine which dangling pronoun gaps to mark as needing repair.

Other

Other types of gaps may also be identified beyond those listed here.

As the gap identification module identifies each gap in the personalized media sequence, it builds a list containing each gap identified, as well as the necessary repair. This preliminary repair list 32 encapsulates all the information needed for the next stage of processing, and is passed to the repair resolution module 34.

Repair Resolution Module (34)

The repair resolution module takes the preliminary repair list and harmonizes potential repairs to create the final repair list for the repair module. Potential repairs in the preliminary repair list will require cross-checking and harmonization because:
1. Several suggested repairs may all indicate extending a media element backward in the source media file. This module will determine that only one repair, extending the element far enough backward, is required.
2. Dangling Name Reference, Dangling Time Reference, Dangling Pronoun, Dangling Demonstrative Pronoun, Dangling Definite Reference, and Speaker Identification gaps may all indicate repair via insertion of additional information. Another repair, extending the media element backward in the source media file, may make unnecessary any of these insertion repairs.
3. Certain types of gaps, including Document Context, Topic Shift, Dangling Name Reference, Dangling Time Reference, Speaker Identification, Missing Local Context, and Specified Relation, may indicate repair via insertion of introductory information. This introductory material may be harmonized into a single coherent unit.
4. A suggested repair may indicate extending a media element backward in the source media file. In cases where that repair would incorporate source material that is already present in the personalized media sequence, the repair is eliminated.
   Gap Repair Module (36)

Taking as input the finalized list of repairs from the Repair Resolution Module, this module modifies the personalized media sequence to perform those repairs. This module automatically fills in missing information by one of three methods:
Segment extension: extending the media element backward in the source media file, to include the necessary information.
Content insertion: inserting a short excerpt from elsewhere in the source media file, to include the necessary information.
Content generation: automatically generating a phrase or sentence, or series of phrases or sentences, conveying the missing information.

The information necessary to this content may be derived from portions of the source media files not utilized in the elements referred to in the media list, as well as from other external information sources. This content may be output as text, automatically generated speech, or in some other form as appropriate.

The preferred embodiment of the invention repairs the gap types identified above as follows:

Document Context Gap Repair

The file metadata available from information extraction contain the contextual information necessary to repair this gap. The precise information provided to the user (file name, file date, date and time of event, source, etc.) may be chosen based on the media request; user profile; genre of source file; application of invention; or combination of these and other factors.

One possible implementation of the invention would have available sentential templates appropriate to these information combinations, allowing it to substitute the correct information into the template and generate the required content. Representative examples include: “CBS News report, Friday, Jul. 1, 2005,” “Surf Kayak Competition, Santa Cruz, Calif.,” “From video: The Internal Combustion Engine. Nebraska Educational Television Council for Higher Education.” This construction of the invention would always repair Document Context gaps via content generation.

Topic Shift

Key topic descriptors determined by the topic description algorithm provide the information necessary to repair this gap. One or two sentential templates are sufficient to generate the required content. For example: “Previous topic: hurricanes. Next: tornadoes.”

The current construction of this invention always repairs Topic Shift gaps via content generation.

Topic Resumption

This is a gap in which two successive media elements share the same source media file and same topic. Repair is accomplished through content generation; no additional information is required for this operation of the invention, as a standard sentence such as “Continuing from the same broadcast:” alerts the viewer to the cut within the media file.

More complex operations of the invention are also possible, utilizing information from the topic description algorithm and the file metadata available from information extraction, in combination with a selection of sentential templates, to generate content such as: “Returning to the topic of foreign earnings:” or “Later in the same Johnny Cash tribute show:”

Dangling Name Reference

Dangling name gaps are repaired through content insertion. The co-reference table used to detect dangling name gaps, provides the information necessary to find the longer name present in the source media file.

The personalized media sequence is emended to include this complete name in place of the original use of the short name. Emendation may be accomplished through:
splicing in audio, or audio and video, of the use of the full name (content insertion);
generated text video overlay (subtitling) with the full name (content generation);
an introductory phrase (content generation).
   Dangling Time Reference

The current construction of this invention always repairs time reference gaps via content generation. Basic sentential templates are sufficient to generate the required time reference (“Recorded Jun. 24, 1994.” “Aired 5 pm, Eastern Standard Time, Jan. 31, 2005.”) which is then inserted into the personalized broadcast, immediately preceding the relevance interval needing repair.

Other constructions of the invention may repair time reference gaps by content generation: calculating the time referred to by the dangling time reference; generating content to describe this time reference; and inserting it into the media element as audio, or as text video overlay (subtitling).

Dangling Pronoun

This invention repairs dangling pronoun gaps through either content insertion or segment extension. Information from the co-reference table provides both the named entity referent for the pronoun, and the point in the source media file at which it occurs.

In the present construction of the invention, if that occurrence is within a chosen horizon, in either time or sentences, of the beginning of the relevance interval, then the media element is extended back to include that named entity reference and repair the gap. Otherwise, the personalized broadcast is emended to include this name in place of the pronoun.

Other

In further construction of the invention, other types of gaps may be repaired beyond those listed here.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of automatically creating a coherent, personalized media sequence of rich media from a group of media elements, the method comprising:
receiving a media list that describes media elements, from the group of media elements, that are appropriate to the personalized media sequence; and
combining the media elements described in the media list into the personalized media sequence, thereby creating a personalized broadcast.

2. The method of claim 1 wherein combining the media elements described in the media list further comprises:
arranging the media elements described in the media list into a media sequence;
detecting gaps in the media sequence; and
repairing the gaps to produce the resulting personalized media sequence of rich media.

3. The method of claim 2 wherein arranging further comprises:
detecting topics of the media elements described in the media list; and
arranging the media elements described in the media list into topically coherent sequences.

4. The method of claim 3 further comprising:
arranging the media elements described in the media list based on additional ordering criteria to order media elements within the topically coherent sequences and to fully order media elements in the personalized sequence of rich media.

5. The method of claim 2 wherein detecting gaps further comprises:
detecting missing contextual/background information within a media element.

6. The method of claim 2 wherein detecting gaps further comprises:
detecting missing bridging information between two adjacent media elements.

7. The method of claim 2 wherein repairing the gaps further comprises:
extending a media element backward in an associated source media file to repair a particular gap.

8. The method of claim 2 wherein repairing the gaps further comprises:
inserting an excerpt at a media element, the excerpt being taken from elsewhere in an associated source media file, to repair a particular gap.

9. The method of claim 2 wherein repairing the gaps further comprises:
inserting generated content at a media element to repair a particular gap.

10. The method of claim 9 wherein the generated content is derived from an associated source media file.

11. The method of claim 9 wherein the generated content is derived from an external information source.

12. The method of claim 9 wherein the generated content is in the form of text.

13. The method of claim 9 wherein the generated content is in the form of speech.

14. The method of claim 9 wherein the generated content is in the form of a text overlay.

15. The method of claim 1 wherein combining the media elements described in the media list further comprises:
arranging the media elements described in the media list into a sequence.

16. The method of claim 15 wherein combining the media elements described in the media list further comprises:
detecting gaps in the media sequence.

17. A programmed system for automatically creating a coherent, personalized media sequence of rich media from a group of media elements, the system being programmed to:
receive a media list that describes media elements, from the group of media elements, that are appropriate to the personalized media sequence; and
combine the media elements described in the media list into the personalized media sequence, thereby creating a personalized broadcast.

18. The system of claim 17 wherein combining the media elements described in the media list further comprises:
arranging the media elements described in the media list into a media sequence;
detecting gaps in the media sequence; and
repairing the gaps to produce the resulting personalized media sequence of rich media.

19. The system of claim 18 wherein arranging further comprises:
detecting topics of the media elements described in the media list; and
arranging the media files and segments described in the media list into topically coherent sequences.

20. The system of claim 19 wherein the system is further programmed to:
arrange the media elements described in the media list based on additional ordering criteria to order media elements within the topically coherent sequences and to fully order media elements in the personalized sequence of rich media.
